(19) United States
(12) Patent Application Publication
(10) Pub. No.: US 2026/0153220 A1
(43) Pub. Date: Jun. 4, 2026

(54) LIGHTING DEVICE

(71) Applicant: SHENZHEN INTELLIROCKS TECH. CO., LTD., SHENZHEN (CN)

(72) Inventors: JUN DAI, SHENZHEN (CN); HAIQIANG SHEN, SHENZHEN (CN); WENLONG WU, SHENZHEN (CN)

(73) Assignee: SHENZHEN INTELLIROCKS TECH. CO., LTD., SHENZHEN (CN)

(21) Appl. No.: 19/405,447

(22) Filed: Dec. 2, 2025

(30) Foreign Application Priority Data
Dec. 2, 2024 (CN) 2024229616307
Dec. 2, 2024 (CN) 2024229680286
Oct. 21, 2025 (CN) 2025222205407

(51) Int. Cl. F21V 5/04; F21S 8/00; F21V 21/30

(52) U.S. Cl. CPC F21V 5/04; F21V 21/30; F21S 8/033

(57) ABSTRACT

Provided are a lighting device and a lamp. The lighting device includes at least two light sources and at least two lenses, the lenses being in one-to-one correspondence with the light sources. Each lens is configured to receive and converge emitted light from a corresponding light source. The at least two lenses are symmetrically arranged. At least a part of a periphery of each lens is arc-shaped. Each lens is configured to make outgoing light therefrom define a zoned light spot, so that an integral fan-shaped light spot is defined by all the zoned light spots.

### CROSS-REFERENCE OF RELATED APPLICATIONS

This application claims priority to Chinese Patent Applications No. 202422961630.7, filed Dec. 2, 2024, No. 202422968028.6, filed Dec. 2, 2024, and No. 202522220540.7, filed Oct. 21, 2025, the entire disclosures of which are all incorporated herein by reference.

### TECHNICAL FIELD

The present disclosure relates to the field of lighting technology, and particularly to a lighting device and a lamp.

### BACKGROUND

Most existing lamps is a single lamp and provide a single light spot effect. Intelligent dimming can only adjust a single color or brightness, while the light spot effect is fixed. Therefore, the existing multi-light source lamps usually has a poor light output performance, which cannot meet the usage demands of numerous scenarios.

### SUMMARY

Embodiments of the present disclosure provides a lighting device and a lamp.

The embodiments of the present disclosure provide a lighting device, which includes at least two light sources and multiple lenses, the multiple lenses being in one-to-one correspondence with the at least two light sources. Each of the lenses is configured to receive and converge emitted light from a corresponding light source. At least a part of a periphery of each lens is arc-shaped, and the multiple lenses are symmetrically arranged. Outgoing light from each lens defines a zoned light spot, and all the zoned light spots define an integral fan-shaped light spot.

The embodiments of the present disclosure further provide a lamp including the above lighting device and a control box, the lighting device and the control box are electrically connected with each other.

### BRIEF DESCRIPTION OF THE DRAWINGS

FIG. 1 is a structural schematic diagram of a lighting device provided in an embodiment of the present disclosure.

FIG. 2 is a top view of the lighting device provided in the embodiment of the present disclosure.

FIG. 3 is an effect diagram illustrating hill-shaped light spots with different colors provided in an embodiment of the present disclosure.

FIG. 4 is an effect diagram illustrating hill-shaped light spots with a same color provided in an embodiment of the present disclosure.

FIG. 5 is a schematic diagram illustrating light spot zoning obtained with an odd number of lenses as provided in an embodiment of the present disclosure.

FIG. 6 is a structural schematic diagram of a lighting device with two lenses as provided in an embodiment of the present disclosure.

FIG. 7 is an effect diagram illustrating hill-shaped light spots with different colors of the lighting device with two lenses as provided in an embodiment of the present disclosure.

FIG. 8 is a schematic diagram illustrating light spot zoning obtained with an even number of lenses as provided in an embodiment of the present disclosure.

FIG. 9 is a diagram illustrating a light path effect of a light-blocking member as provided in an embodiment of the present disclosure.

FIG. 10 is a structural schematic diagram of the lighting device as provided in another embodiment of the present disclosure.

FIG. 11 is a schematic exploded diagram of the lighting device illustrated in FIG. 10 according to an embodiment.

FIG. 12 is a schematic longitudinal cross-sectional diagram of the lighting device illustrated in FIG. 10 according to an embodiment.

FIG. 13 is a structural schematic diagram of a rotational connection mechanism of the lighting device illustrated in FIG. 11.

FIG. 14 is another structural schematic diagram of the rotational connection mechanism illustrated in FIG. 13.

FIG. 15 schematically illustrates a three-dimensional cross-sectional diagram of the lighting device illustrated in FIG. 12.

FIG. 16 is a schematic exploded diagram of the lighting device illustrated in FIG. 10 according to a further embodiment.

FIG. 17 is a schematic longitudinal cross-sectional diagram of the lighting device illustrated in FIG. 16 in an assembled state according to the further embodiment.

FIG. 18 is a structural schematic diagram of the rotational connection mechanism of the lighting device illustrated in FIG. 16.

### DETAILED DESCRIPTION OF PREFERRED EMBODIMENTS

The present disclosure will be further described in detail below in conjunction with the drawings and embodiments. It is understandable that the specific embodiments described herein are only used to explain the present disclosure, rather than limiting the present disclosure. In addition, it is notable that, for the convenience of description, only the parts related to the present disclosure, not all structures, are illustrated in the drawings.

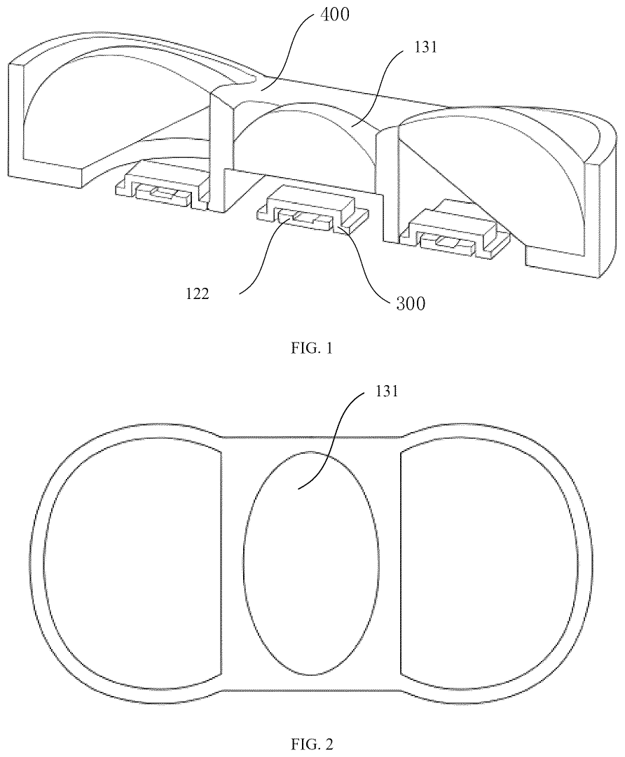

FIG. 1 is a structural schematic diagram of a lighting device provided in an embodiment of the present disclosure, and the embodiment may be applied to lamps such as wall washer lamps. As illustrated in FIG. 1, the lighting device includes at least two light sources 122 and multiple lenses 131, and the multiple lenses are in one-to-one correspondence with the at least two light sources. Each lens 131 is configured to receive and converge the emitted light from a corresponding light source 122. At least a part of the periphery of each lens is arc-shaped, and the multiple lenses 131 are symmetrically arranged. The outgoing light from each lens 131 defines a zoned light spot, and all the zoned light spots together define an integral fan-shaped light spot.

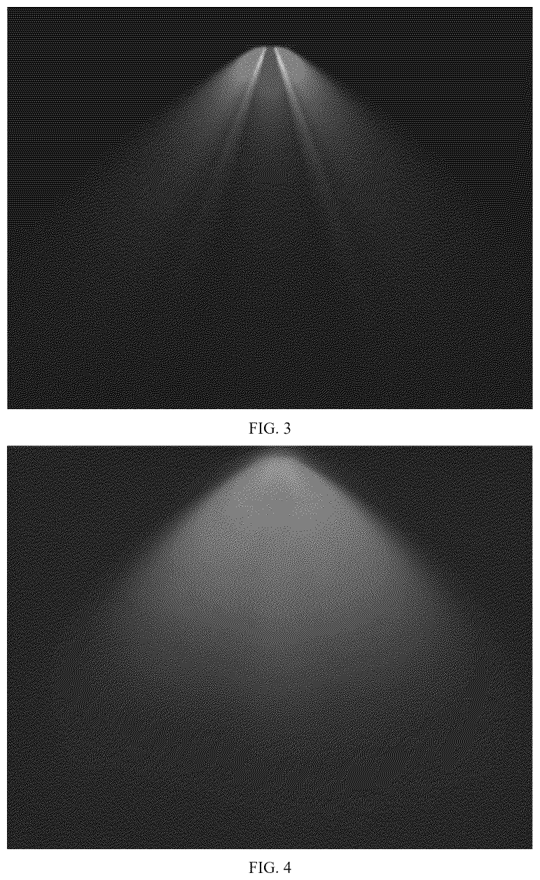

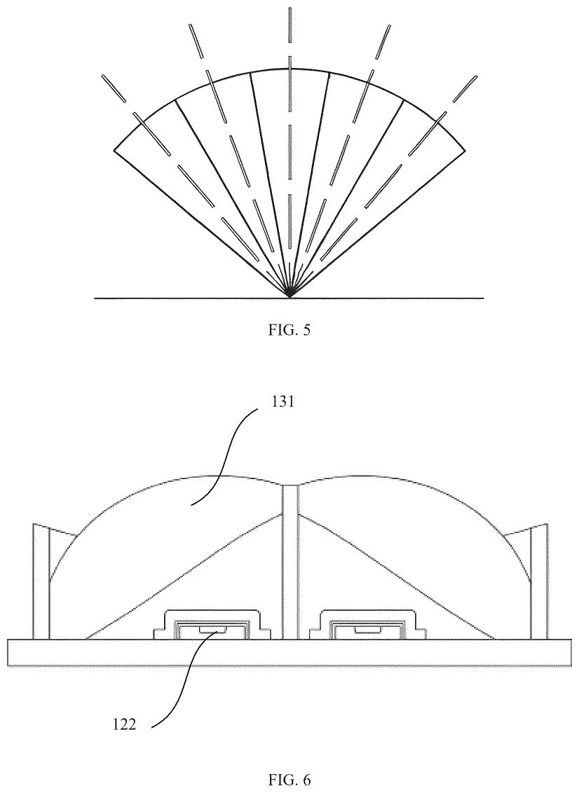

Specifically, the number of the light sources 122 may be any number greater than or equal to two, and correspondingly, the same number of lenses 131 are included. FIG. 1 illustrates an example which includes three sets of light source 122 and lens 131 with each set including one light source 122 and one corresponding lens 131. The lens 131 may receive the emitted light from its corresponding light source 122, converge it, and then emit it from its light exit surface. The multiple lenses 131 are symmetrically arranged, and the outgoing light from each lens 131 may define a zoned light spot. In addition, all the zoned light spots defined by the individual lenses 131 may jointly define an integral fan-shaped light spot (that is, the outgoing/output light of the lighting device is substantially a fan-shaped light beam). That is, on the basis of generating multiple zoned light spots, there is not much overlapping light between the zoned light spots, and they are closely arranged. In some implementations, the light source 122 includes at least one of white LED, RGB color LED, and RGBWW five-color LED, and each light source 122 is independently controlled. Thus, the individual light sources 122 may be controlled to emit light of a same color or different colors and same or different brightness. When the colors and brightness of light emitted by individual light sources 122 are the same, the overall looks a fan-shaped light spot; and when the colors and brightness of light emitted by individual light sources 122 are not completely the same, independent and different zoned light spots can be achieved. The light sources 122 may be arranged at intervals along a straight line or an arc. In some implementations, each lens 131 is a dual free-form surface lens, that is, the light incident surface and the light exit surface of each lens 131 are all free-form surfaces, so as to realize adjustment of the zoned light spot. As illustrated in FIG. 2, the shape of the receiving surface of each lens 131 facing the corresponding zoned light spot may be arc-shaped, so that the individual zoned light spots may be spliced to obtain a hill-like fan-shaped light spot, which can reduce light overlap and make the outgoing/output light more uniform. The effect of different color light spots emitted by individual independent zones is illustrated in FIG. 3, and the effect of same color light spots emitted by individual independent zones is illustrated in FIG. 4.

In an example, the individual light sources have a same emission angle. That is, the central angle of the finally defined integral fan-shaped light spot may be equally divided according to the number of the lenses 131, and by designing the curvatures of the light incident surface and the light exit surface of each lens 131, the outgoing angle of the zoned light spot defined by each lens 131 is an average value obtained through the equal division, and the optical axis of each lens 131 is located at the center of each divided zone, so that the finally obtained fan-shaped light spot is more uniform. The central angle of the entire fan-shaped light spot may be 80-120 degrees. Taking three sets of light source 122 and lens 131 as an example, assuming that the central angle of the fan-shaped light spot composed of three zoned light spots is 122 degrees, the outgoing angle of each zoned light spot is 122/3 degrees, that is, about 33 degrees.

In an example, the number of the lenses 131 is odd, the lenses 131 include a central lens whose optical axis coincides with the optical axis of the fan-shaped light spot, and the other lenses except the central lens are symmetrically arranged on both sides of the central lens. Specifically, the central lens may be symmetric in the arrangement direction of the individual lenses 131 and a direction perpendicular to the arrangement direction, on a plane of the receiving surface facing the corresponding zoned light spot. The other lenses are symmetrically arranged on both sides of the central lens, and two of the other lenses at symmetric positions may have the same shape.

Furthermore, in some implementations, an angle between the optical axis of an i-th other lens on each side of the central lens and the optical axis of the fan-shaped light spot is i*N/M, where N represents the degree of the central angle of the fan-shaped light spot, M represents the number of the lenses 131, and i is a positive integer less than or equal to (M−1)/2. The tilt angle of the central lens may be 0 degree, and the tilt angles of the other lenses in different zones on the same side of the central lens are different, which change with the required deflection of the optical axis. Correspondingly, there may be (M+1)/2 types of lenses, the outgoing angle of the zoned light spot defined by each lens is N/M obtained through equal division, and the tilt angle of each type of lens may be 0, N/M, 2N/M, 3N/M, etc., in sequence relative to the optical axis direction of the fan-shaped light spot. For example, taking five sets of light source 122 and lens 131 as an example, assuming that the central angle of the fan-shaped light spot composed of five zoned light spots is 122 degrees, there are three types of lenses. The tilt angle of the central lens is 0 degree, the tilt angle of the first other lens on each side is 20 degrees, and the tilt angle of the second other lens on each side is 40 degrees. The schematic diagram of light spot zoning of the lighting device with five sets of light source and lens is illustrated in FIG. 5.

In an example, the number of the lenses 131 is even, and all the lenses 131 are symmetrically arranged on both sides of the optical axis of the fan-shaped light spot. Specifically, as illustrated in FIG. 6, taking two sets of light source 122 and lens 131 as an example, the two lenses 131 are symmetrically arranged on both sides of the optical axis of the fan-shaped light spot, and the two lenses at symmetric positions may have the same shape. The effect of light spots with different colors is illustrated in FIG. 7.

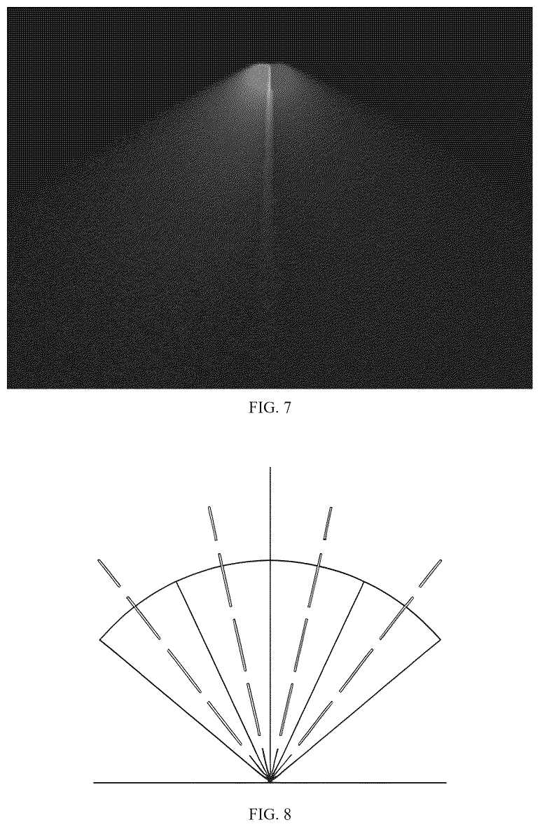

Furthermore, in some implementations, an angle between the optical axis of the fan-shaped light spot and an optical axis of an i-th lens on each side of the optical axis of the fan-shaped light spot is (2i−1)*N/(2M), where N represents the degree of the central angle of the fan-shaped light spot, M represents the number of the lenses, and i is a positive integer less than or equal to M/2. Specifically, the tilt angles of the lenses in different zones on the same side of the optical axis of the fan-shaped light spot are different, which change with the required deflection of the optical axis. Correspondingly, there may be M/2 types of lenses, the outgoing angle of the zoned light spot defined by each lens is N/M obtained through equal division, and the tilt angle of each type of lens may be N/(2M), 3N/(2M), 5N/(2M), etc., in sequence relative to the optical axis direction of the fan-shaped light spot. For example, taking four sets of light source 122 and lens 131 as an example, assuming that the central angle of the fan-shaped light spot composed of four zoned light spots is 122 degrees, there are two types of lenses, the tilt angle of the first lens on each side of the optical axis of the fan-shaped light spot is 12.5 degrees, and the tilt angle of the second lens on each side is 37.5 degrees. The schematic diagram of light spot zoning of the lighting device with four sets of light source and lens is illustrated in FIG. 8.

In an example, as illustrated in FIG. 1, a light mixing cover 300 is provided in the emission direction of each light source 122, so as to improve the uniformity of light mixing. Specifically, the light mixing cover 300 may be arranged around its corresponding light source 122, and the emitted light from the light source 122 is incident on the corresponding lens 131 after passing through the corresponding light mixing cover 300.

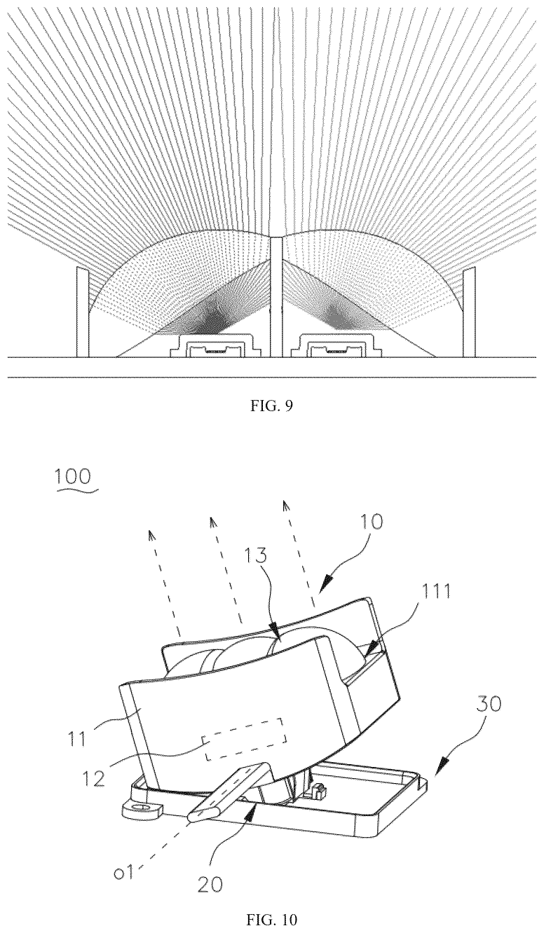

In an example, as illustrated in FIG. 1, a light-blocking member 400 is provided around each lens 131, and the light-blocking member 400 is also provided between every two adjacent lenses 131, so as to separate the individual lenses 131, preventing mutual light interference, and allowing closer arrangement. This make the outgoing/output light more uniform. Moreover, the light-blocking member 400 provided around the outer periphery of the lens can also block some stray light, making the overall fan-shaped light spot clearer. The effect thereof is illustrated in FIG. 9.

In the lighting device provided in the above embodiments of the present disclosure, multiple independent zoned light spots are enabled through multiple sets of light source and lens, which improves the adjustability of the light spots. In addition, all the zoned light spots define an integral fan-shaped light spot without affecting the overall lighting effect. Furthermore, the arc-shaped periphery of the lens can reduce light overlap, making more the outgoing/output light more uniform.

Referring to FIG. 10, a lighting device 100 is provided in another embodiment of the present disclosure. The lighting device 100 is configured to provide lighting or emit light to a light-receiving surface, and the light-receiving surface may be a ceiling, a wall, a floor, etc. As an example, the lighting device 100 is used for a wall washer lamp configured to provide lighting for a wall. The lighting device 100 includes a lamp body 10, a rotational connection mechanism 20, and a base 30. Since the lamp body 10 of the lighting device 100 can be rotated relative to the base 30, the lighting device 100 can project light to the wall in different directions without changing the installation position. The outgoing direction and outgoing angle of the lighting device 100 may also be adjusted according to different distances from the wall, thereby improving the light output effect and the convenience and flexibility of the lighting device 100.

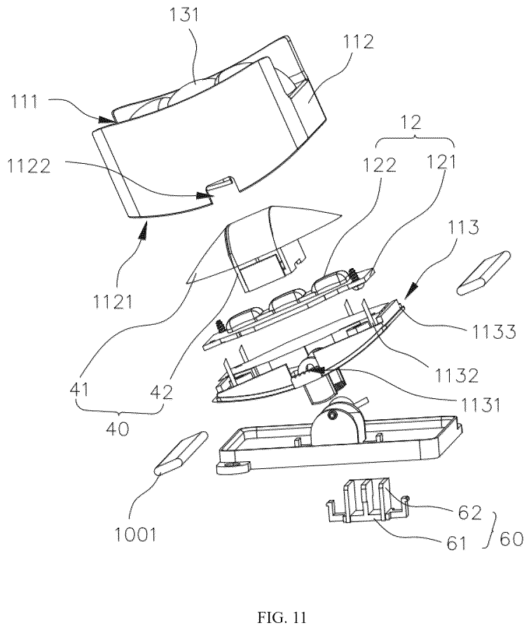

Specifically, referring to FIG. 10 and FIG. 11, the rotational connection mechanism 20 is connected between the base 30 and the lamp body 10, and the lamp body 10 is rotatable relative to the base 30 around a preset axis O1 via the rotational connection mechanism 20. The lamp body 10 includes a housing assembly 11, a light-emitting module 12, and a lampshade 13. The housing assembly 11 is connected to the rotational connection mechanism 20, and the housing assembly 11 is provided with a light outlet 111. The light-emitting module 12 includes the light sources 122, and the lampshade 13 includes the lenses 131. These light sources 122 and lenses 131 may be the same as those in the embodiments illustrated in FIG. 1 to FIG. 9. The light-emitting module 12 is provided in the housing assembly 11, and the light emission direction of the light-emitting module 12 faces the light outlet 111. The lampshade 13 is provided at the light outlet 111 and covers the light outlet 111. The light-emitting module 12 is installed in the housing assembly 11, and the light-emitting side of the light-emitting module 12 faces the light outlet 111. A direction from the light-emitting side to the light outlet 111 is defined as the light emission direction of the light-emitting module 12, and the preset axis O1 intersects the light emission direction.

By providing the rotational connection mechanism 20, the lamp body 10 is enabled to rotate relative to the base 30 around the preset axis O1, so that the lighting direction of the lighting device 100 can be adjusted as needed to improve the light output effect. In the embodiments, the light emission direction of the light-emitting module 12 is set as a direction from the light-emitting side of the light-emitting module 12 to the light outlet 111, which can ensure that the light can effectively propagate from the light-emitting module 12 to the external environment. In addition, the light emission direction intersects the preset axis O1, which can enable the control of the light irradiation direction, avoid unnecessary light waste, and improve the lighting efficiency.

Continuing to refer to FIG. 10 and FIG. 11, the lamp body 10, as the light-emitting part of the lighting device 100, is configured to project light to the light-receiving surface. The lamp body 10 is rotatable relative to the base 30 around the preset axis O1 via the rotational connection mechanism 20, thereby defining various light exit angles. The lamp body 10 may include the housing assembly 11, the light-emitting module 12, and the lampshade 13. The housing assembly 11 serves as an installation carrier for installing the light-emitting module 12, the lampshade 13, or other components, and protecting the components from external influences.

The housing assembly 11 may include a housing 112 and a bottom cover 113 connected to each other. When the bottom cover 113 is covered on the housing 112, the bottom cover 113 and the housing 112 together define an accommodating space 1121 for installing the above components. The housing 112 is roughly cylindrical with an inner cavity. The material of the housing 112 may include ABS plastic, PC plastic, or other hard plastics, which can not only reduce the weight of the housing assembly 11 to achieve lightweight, but also make the housing assembly 11 have a certain stability, thereby effectively protecting the components inside the housing assembly 11. In addition, the plastic material has characteristics of low cost, good plasticity, easy processing, and not easy to break, which can reduce the production cost of the lighting device 100. The material of the housing 112 may also be other metal materials such as aluminum, stainless steel, or copper, or ceramic materials.

In the embodiments, the housing assembly 11 has the light outlet 111. The light outlet 111 is communicated with the accommodating space 1121, and is provided on a side of the housing 112 facing the light-receiving surface to facilitate the direct propagation of light to the light-receiving surface. In order to improve the sealed connection between the lampshade 13 and the housing assembly 11, in the embodiments, the lampshade 13 may be integrally formed with the housing 112. In some other embodiments, the lampshade 13 may also be detachably connected to the housing 112.

The light-emitting module 12 is installed in the accommodating space 1121. The light-emitting module 12 is configured to generate light. The light-emitting module 12 has a light-emitting side, with the light-emitting side facing the light outlet 111. The light-emitting module 12 has the light emission direction from the light-emitting side to the light outlet 111, and the preset axis O1 intersects the light emission direction. The light-emitting module 12 may include a substrate 121 and the light sources 122. The light sources 122 are detachably connected to a side of the substrate 121 close to the light outlet 111 for easy disassembly, assembly, and replacement. The side where the light sources 121 are located is the light-emitting side of the light-emitting module 12. The substrate 121 is configured to supply power to the light sources 122 and realize the conductive connection between the light sources 122 and an external circuit. The substrate 121 may be a circuit board or a dielectric substrate. As an example, the substrate 121 is a circuit board which is roughly plate-shaped, and the light sources 122 are provided on the circuit board. The circuit board may be a flexible circuit board or a printed circuit board.

In the embodiments, the light source 122 is an LED light source, which may be a single-color LED light source or a three-color LED light source. It is notable that, it is illustrated in the disclosure by taking a case where there are multiple light sources as an example, but the number of the light sources 122 may also be one. When there are multiple light sources 122, the multiple light sources 122 are arranged on the substrate 121 in sequence. The multiple light sources 122 may have different colors, so as to provide outgoing/output light of multiple colors and improve the lighting effect. By providing the LED light source 122, in one aspect, the efficiency of converting electrical energy into light energy can be improved to reduce energy waste, and energy saving and environmental protection is also enabled since the LED light source generates less heat during lighting; and in another aspect, the LED light source has a long service life, which reduces the frequency of light source replacement and thus lowers the use cost. In addition, LEDs can avoid damage to human eyes and improve the safety of use. The light-emitting module 12 may also adopt other light-emitting sources, such as laser light sources.

In some embodiments, when the light-emitting module 12 includes multiple light sources 122, multiple lenses 131 may be provided on the lampshade 13. The lenses 131 may be integrally formed with the lampshade 13 or detachably installed on the lampshade 13. The lenses 131 are configured to concentrate light. The multiple lenses 131 are provided in one-to-one correspondence with the multiple light sources 122, to improve the light emission effect of each light source 122. In the embodiments, the multiple lenses 131 are connected in sequence, and the multiple connected lenses 131 are in an arc shape and cover the light outlet 111. Each light source 122 corresponds to a different lens 131, that is, the light emitted by the individual light sources 122 is emitted through different parts of the arc-shaped region, which enables lighting of various ranges or angles. Moreover, the emitted light from each light source 122 may be emitted through a separate lens 131, which enables accurate control of the direction and distribution of the light, making the lighting more directional and concentrated. Furthermore, the provision of the lenses 131 can improve the uniformity of light, and reduce dark areas and bright spots in the lighting area, thereby providing a more comfortable lighting environment.

In order to further improve the light output effect, in some embodiments, the lighting device 100 may further include a light-blocking mask 40. The light-blocking mask 40 is provided in the housing assembly 11, specifically provided between the light-emitting module 12 and the light outlet 111. The light-blocking mask 40 may include a mask body 41 and multiple spacer plates 42, and the mask body 41 are connected with the multiple spacer plates 42. The mask body 41 may be attached to the lenses 131 to prevent glare caused by direct irradiation of the light source 122 or reflection thereof, and provide a more comfortable visual environment. The spacer plates 42 may be regarded as the light-blocking member 400 illustrated in FIG. 1. The multiple spacer plates 42 extend from a side of the mask body 41 facing the light sources 122, to divide the space defined by the mask body 41 into multiple subspaces, that is, each spacer plate 42 is provided between two adjacent light sources 122. By providing the light-blocking mask 40, the mask body 41 and the spacer plate 42 are utilized to effectively prevent mutual light interference between adjacent light sources 122 and improve the light output effect.

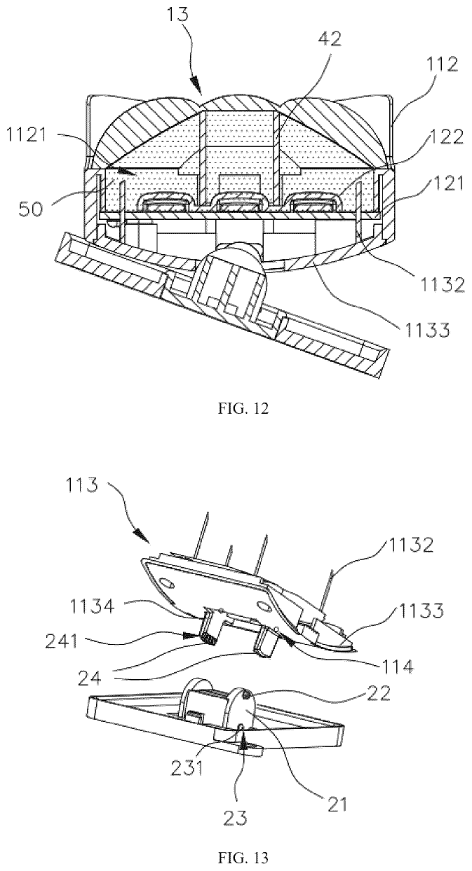

Referring to FIG. 11 and FIG. 12, in order to protect the light-emitting module 12 and other sensitive electronic components from being eroded by the external environment, such as the intrusion of moisture, dust, etc., the lighting device 100 may further include a potting sealing element 50. The potting sealing element 50 is filled in the space defined between the substrate 121 and the lampshade 13. Specifically, the potting sealing element 50 may be a potting adhesive, which may be made of waterproof and thermally conductive materials. For example, after the light-emitting module 12 and/or other electronic components are installed in the accommodating space 1121, liquid potting adhesive is filled into the accommodating space 1121. After the liquid potting adhesive is cured, it may play a role in waterproofing and moisture-proofing. In order to further improve the sealed connection performance of the light-emitting module 12 and the lighting device 100, the potting adhesive may cover a side of the substrate 121 away from the lampshade 13, so that the light-emitting module 12 or other electronic components are completely embedded in the potting adhesive. By providing the potting sealing element 50, in one aspect, it can encapsulate and fix the light-emitting module 12 and other electronic components, and effectively prevent the electronic components from being eroded by moisture, dust, and other external environments, thereby improving the stability and reliability of the electronic components; and in another aspect, it can reduce the vibration that the lighting device 100 may encounter during transportation or use, and provide an additional insulating layer to protect the electronic components from electrical interference and prevent accidental short circuits.

Referring to FIG. 11 and FIG. 12, in the embodiments, the bottom cover 113 is detachably connected to the housing 112 for easy disassembly, assembly, and maintenance. The lighting device 100 further includes a wire 1001. The bottom cover 113 is configured to fix the wire 1001 with the housing 112, and define the accommodating space 1121 with the housing 112. Specifically, the bottom cover 113 includes a cover body 1133 and plug connectors 1132, and the cover body 1133 are connected with the plug connectors 1132. The cover body 1133 is connected to a side of the substrate 121 away from the light outlet 111, and is configured to cover the accommodating space 1121 of the housing 112. The plug connectors 1132 are configured to provide stable fixation for the electronic components inside the lighting device 100. One end of each plug connector 1132 is connected to the cover body 1133, and the other end of each plug connector passes through a gap between the substrate 121 and the housing 112 and is then inserted into the potting sealing element 50. By providing the plug connectors 1132, the bottom cover 113 can be firmly connected to the potting sealing element 50, thereby further improving the firm connection between the bottom cover 113 and the housing 112, and preventing separation of the wire 1001 from the light-emitting module 12 that would be caused by the rotation of the lamp body 10.

In the embodiments, the housing 112 is further provided with a wire passing hole 1122. The wire passing hole 1122 is configured for the wire 1001 to pass through, and the wire 1001 is configured to supply power to the substrate 121. Specifically, the two sides of the housing 112 are provided with wire passing holes 1122 communicated with the accommodating space 1121. The wire passing holes 1122 may be specifically provided on an end of the housing 112 close to the bottom cover 113, and the wire 1001 passes through the wire passing holes 1122 and is connected to the substrate 121. In order to facilitate the passing of the wire 1001, the bottom cover 113 may further be provided with a matching hole 1131 matched with the wire passing hole. Both the matching hole 1131 and the wire passing hole 1122 looks like a notch. When the housing 112 and the bottom cover 113 are connected together, the matching hole 1131 and the wire passing hole 1122 are communicated to define a large hole structure. The aperture of the large hole structure is smaller than the thickness of the wire 1001, so that the wire 1001 is clamped between the housing 112 and the cover body 1133 when passing through the large hole structure for connection to the substrate 121.

In the embodiments, the bottom cover 113 is also configured to be connected to the rotational connection mechanism 20, and the rotational connection mechanism 20 is also connected to the base 30, so that the lamp body 10 is rotatable relative to the base 30 via the rotational connection mechanism 20. The base 30 is configured to be supported at the use place of the lighting device 100, for example an installation platform such as a wall, a desktop, or a floor. As an example, during installation of the lighting device 100, the base 30 is attached to the wall or an installation frame connected to the wall, which may have a relatively large projection area, so that the base 30 may be relatively stably placed on the installation surface, to provide good support for the entire lighting device 100 and keep the overall position of the lighting device 100 stable. In order to further enhance the stability of the lighting device 100, the base 30 may also be provided with a stabilizing member (not shown in the figure), the stabilizing member is provided on the base 30 to prevent the lighting device 100 from shifting or flipping during use.

Referring to FIG. 11 and FIG. 13, in the embodiments, the rotational connection mechanism 20 is connected between the lamp body 10 and the base 30, and serves as a key structure that enables the lamp body 10 to be rotated relative to the base 30 around the preset axis O1. The rotational connection mechanism 20 includes a support member 21 and a rotating shaft portion 22. The rotating shaft portion 22 is provided on the support member 21, and the housing assembly 11 is provided with a shaft hole 114. When the rotating shaft portion 22 is rotatably received in the shaft hole 114, the lamp body 10 can be rotated relative to the base 30 around the preset axis O1. Specifically, there are two support members 21, and the two support members 21 are spaced apart to improve the support stability. One end of each support member 21 is connected to the base 30, and the other end thereof extends toward the lamp body 10. The end of each support member 21 close to the lamp body 10 is provided with the rotating shaft portion 22. The rotating shaft portion 22 is a protruding structure, which protrudes toward the outer side of the support member 21, and the outer side may be understood as a side of each support member away from a space between the two support members 21.

In the embodiments, the rotational connection mechanism 20 may further include an extension member 1134. The extension member 1134 is configured to cooperate with the support member 21 to realize the rotation of the lamp body 10 relative to the base 30. There are two extension members 1134. Each of the two extension members 1134 is opposite to and stacked with one corresponding support member 21, and the two support members 21 are located between the two extension members 1134. One end of each extension member 1134 is connected to the bottom cover 113, and the other end thereof extends toward the support member 21. Each extension member is provided with a shaft hole. For example, there are two shaft holes 114, and the two shaft holes 114 are respectively provided at the ends of the two extension members 1134 away from the base 30. During installation of the lighting device 100, each of the two extension members 1134 is placed to be opposite to and stacked with one corresponding support member 21, so that the two rotating shaft portions 22 are respectively accommodated in corresponding shaft holes 114, and can rotate relative to the shaft holes 114.

It is notable that the above arrangement of the rotating shaft portion 22 at the end of the support member 21 and the shaft hole 114 at the end of the extension member 1134 is to reduce the overall volume of the lighting device 100. The shaft hole 114 may also be provided at other positions of the corresponding extension member 1134, and the rotating shaft portion 22 may also be set at other positions of the corresponding support member. In some other embodiments, the rotating shaft portions 22 may also be provided on the housing assembly 11, and the shaft holes 114 are provided on the support member 21, so that through installation of the lighting device 100, the rotating shaft portion 22 and the shaft hole 114 are rotatably connected and cooperate with each other, to enable rotation of the lamp body 10 relative to the base 30.

Referring to FIG. 13, in some embodiments, in order to reduce twisting damage to wire or friction damage caused by infinite rotation of the lighting device 100 in the rotation direction, the lighting device 100 may further include a positioning portion 23 and a matching portion 24. Both the positioning portion 23 and the matching portion 24 are provided on the rotation path on which the lamp body 10 is rotated relative to the base 30. For example, the rotation path is a circumference or arc with the central axis of the support member 21 as the center, and the positioning portion 23 and the matching portion 24 are both provided on the circumference or arc of the same radius. It is understandable that the rotation path is not necessarily a visible path, but a virtual path that objectively exists during the rotation of the lamp body 10 relative to the base 30. Specifically, the positioning portion 23 is provided on the support member 21, and the matching portion 24 is provided on a side of the extension member 1134 away from the housing assembly 11. When the rotating shaft portion 22 is movably connected to the shaft hole 114, the positioning portion 23 and the matching portion 24 are cooperatively connected to limit the relative position between the housing assembly 11 and the base 30. That is, when the housing assembly 11 is rotated to a limit angle in a single direction relative to the base 30, the positioning portion 23 is clamped in or abuts against the matching portion 24, thereby avoiding friction damage or wire damage caused by excessive rotation of the lighting device 100. One of the positioning portion 23 and the matching portion 24 may be a groove, and the other one of them may be a protruding structure. As an example, the positioning portion 23 may be a protruding structure 231, and the matching portion 24 may be a groove 241, and the protruding structure 231 is capable of being clamped in the groove 241. It is notable that there may be one or more positioning portion 23; when there is one positioning portion 23, it may be provided on any one of the two support members 21; when there are two positioning portions 23, they may be provided on the two support members 21 respectively; and when there are more than two positioning portions 23, each of the two support members 21 may be provided with at least one positioning portion 23, which is not limited in the disclosure.

There may be two or more matching portions 24. As an example, when the matching portion 24 is a groove 241 and there are two matching portions 24, the two matching portions 24 are respectively located at the limit positions of the lamp body 10 in rotating along two opposite directions, such as left and right directions. When the lamp body 10 is rotated along the rotation path, it may be relatively far away from or close to the matching portion 24. When the positioning portion 23 and one of the matching portions 24 contact each other, it shows that the rotation of the lamp body 10 relative to the base 30 has reached the limit angle. As another example, when the matching portion 24 is a groove 241 and there are multiple matching portions 24, the multiple grooves 241 are arranged in sequence and located on the outer circumference of the rotating shaft portion 22, and the protruding structure 231 is rotatably clamped in one of the multiple grooves 241 to realize suspending at that angle. It is notable that, a case where two or more matching portions 24 are provided on one extension member 1134 is illustrated in the foregoing, and when each support member 21 is provided with at least one positioning portion 23, each extension member 1134 may be provided with at least one matching portion 24 at the position described above.

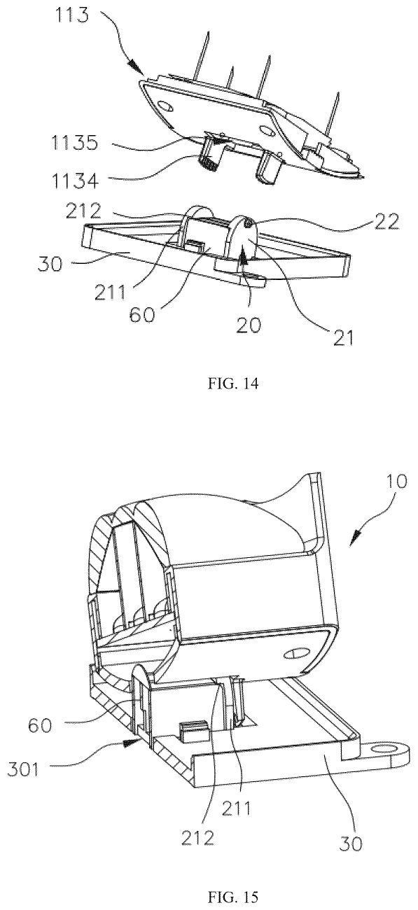

Referring to FIG. 11, FIG. 14, and FIG. 15, in order to further improve the connection firmness of the lamp body 10, the base 30, and the rotational connection mechanism 20, the lighting device 100 may further include a fixing pin 60. The fixing pin 60 is connected with all of the lamp body 10, the base 30, and the rotational connection mechanism 20. Specifically, the bottom cover 113 is provided with a first through hole 1135 which is communicated with the accommodating space 1121. The two extension members 1134 may be connected to the hole walls of the first through hole 1135 respectively. The base 30 is provided with a second through hole 301 which is communicated with the first through hole 1135. The two support members 21 may be connected to the hole walls of the second through hole 301 respectively. The fixing pin 60 sequentially passes through the second through hole 301 and the first through hole 1135, and is connected to all of the base 30, the rotational connection mechanism 20, and the lamp body 10. Specifically, the fixing pin 60 includes a fixing seat 61 and a fixing insert 62 connected to each other, and the fixing insert 62 is plate-shaped. When the rotating shaft portion 22 and the shaft hole 114 are rotatably connected in a matching manner, the support member 21 and the extension member 1134 of the rotational connection mechanism are stacked with each other, and the fixing pin 60 is clamped between the two support members 21.

Each support member 21 includes a body portion 211, and a protruding portion 212 protruding relative to the body portion 211. The protruding portion 212 is provided on a side of the body portion 211 away from the rotating shaft portion 22, that is, the protruding portion 212 is provided on a side of the support member 21 facing the fixing pin 60. The protruding portion 212 and the body portion 211 of the support member 21 together define a groove structure. In installing the fixing pin 60, one end of the fixing seat 61 is clamped in the second through hole 301 of the base 30, and the fixing insert 62 passes through the second through hole 301 and abuts against the groove structure, to realize the clamping connection of the base 30, the rotational connection mechanism 20, and the lamp body 10. It is notable that the number of the fixing inserts 62 may be one or more. The provision of multiple fixing inserts 62 is to improve the structural strength of the fixing pin 60 and the firmness of the connection. The specific number of the fixing inserts 62 is not limited in the embodiments.

In the lighting device 100 provided in the above embodiments of the present disclosure, through provision of the rotational connection mechanism 20, the lamp body 10 is enabled to be rotated relative to the base 30 around the preset axis O1, so that the lighting direction of the lighting device 100 can be adjusted as needed to improve the light output effect. The lamp body 10 further includes the housing assembly 11, the light-emitting module 12, and the lampshade 13. The light emission direction of the light-emitting module 12 is set as a direction from the light-emitting side of the light-emitting module 12 to the light outlet 111, which can ensure that the light can effectively propagate from the light-emitting module 12 to the external environment. In addition, the light emission direction intersects the preset axis O1, which enables control of the light irradiation direction, avoids unnecessary light waste, and improves the lighting efficiency.

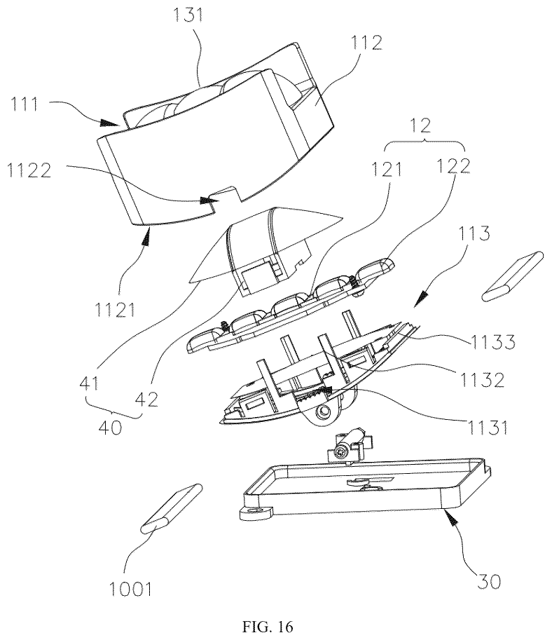

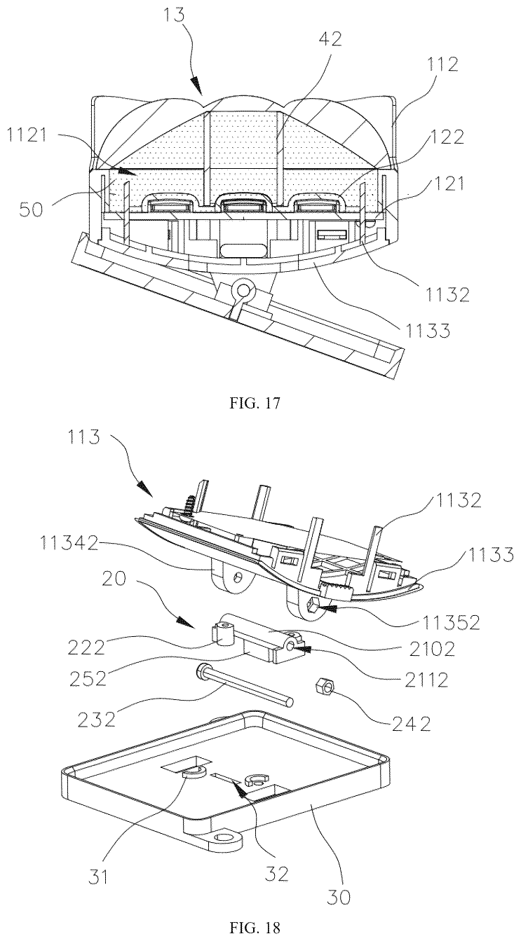

Referring to FIG. 11 and FIG. 16, in the lighting device 100 provided by another embodiment, the rotational connection mechanism 20 is connected between the base 30 and the lamp body 10, there is rotational damping when the lamp body 10 is rotated relative to the base 30 around the preset axis O1 based on the rotational connection mechanism 20, and the lamp body 10 can remain suspended relative to the base 30 under the action of the rotational damping. Thus, the lamp body 10 can remain suspended at a predetermined angle under the action of the rotational damping. The suspending operation is simple and fast without an additional locking mechanism, which can improve the operation efficiency and the user's use experience.

Referring to FIG. 11, FIG. 16, and FIG. 18, in the embodiment, the rotational connection mechanism 20 is connected between the lamp body 10 and the base 30. As a key structure that enables the lamp body 10 to be rotated relative to the base 30 around the preset axis O1, the rotational connection mechanism 20 includes a rotating shaft 2102 and a fixing portion 222 connected to each other. The overall volume of the rotating shaft 2102 and the fixing portion 222 is small, so that there is a small distance between the lamp body 10 and the base 30, making the lighting device 100 have a small overall volume and be easy to carry and transport. There may be two fixing portions 222. The two fixing portions 222 are respectively provided at two ends such as the left and right ends of the rotating shaft 2102. The fixing portion 222 is configured be inserted into and connected with the base 30, to realize the fixed connection between the rotational connection mechanism 20 and the base 30. As an example, the base 30 is provided with matching members 31 matched with the fixing portions 222. One of the fixing portion 222 and the matching member 31 may be a groove, the other of them may be a protruding structure, and the protruding structure may be received in the groove. In the embodiments, the fixing portion 222 may be a protruding structure which protrudes toward the base 30, and the matching member 31 may be a groove.

The rotating shaft 2102 is movably connected between the lamp body 10 and the base 30, and is configured to allow the lamp body 10 to be rotated relative to the base 30 around the preset axis O1. The rotating shaft 2102 may be specifically movably connected to the housing assembly 11 of the lamp body 10 through a shaft hole, or through a hinge, a coupling, or other structures. In the embodiments, the rotating shaft 2102 is movably connected to the housing assembly 11 through a shaft hole. Specifically, two fixing members 11342 are provided on a side of the housing assembly 11 facing the base 30. The two fixing members 11342 may be specifically provided on the bottom cover 113. The two fixing members 11342 are spaced apart from each other to improve the stability of the rotational cooperation with the rotating shaft 2102. Each fixing member 11342 is provided with a first shaft hole 11352. The rotating shaft 2102 is located between the two fixing members 11342 by means of a penetrating member 232 passing through the two first shaft holes 11352. Thus, when the rotating shaft 2102 is rotated between the two fixing members 11342, the lamp body 10 is rotated relative to the base 30 around the preset axis O1 to define various light output angles. The preset axis O1 intersects the light emission direction.

In the embodiments, the rotational connection mechanism 20 further includes fasteners 242 and the penetrating member 232. After the penetrating member 232 passes through the rotating shaft 2102 and the first shaft holes 11352, the fasteners 242 are connected to the penetrating member 232 at two sides thereof. The penetrating member 232 and the fasteners 242 are configured to tightly abut against both sides of the fixing members 11342, and the frictional force among the three makes the two fixing members 11342 clamp the two ends of the rotating shaft 2102. Specifically, the rotating shaft 2102 is provided with a second shaft hole 2112 which runs through the rotating shaft 2102 along the rotation axis direction of the rotating shaft 2102. The penetrating member 232 is rod-shaped, and is received in the second shaft hole 2112 and can move relative to the rotating shaft 2102. It is notable that the penetrating member 232 may move relative to the inner wall surface of the second shaft hole 2112 or be fixed in the second shaft hole 2112. The fastener 242 may be a nut. After the penetrating member 232 passes through the second shaft hole 2112 and the first shaft holes 11352 in sequence, the penetrating member 232 is connected to the fasteners 242 and the fasteners 242 tightly abut against both sides of the two fixing members 11342, so that the two fixing members 11342 jointly clamp the two ends of the rotating shaft 2102. At this time, one end of the penetrating member 232 is clamped by one fixing portion 222 and an end surface of the rotating shaft 2102, and the other end of the penetrating member 232 is connected to the fastener 242 and clamped by the fastener 242, the other end surface of the rotating shaft 2102, and the other fixing portion 222. The frictional force provides the rotational damping. Under the action of an external force, the lamp body 10 is rotated to a certain angle relative to the base through the rotating shaft 2102; and after the external force is removed, the frictional force may keep the lamp body relatively stationary with the base at that angle. The rotating shaft 2102 in the embodiment is equivalent to a rotational damper, which provides a damping effect through the viscoelasticity of the material of the rotating shaft 2102 itself. The material of the rotating shaft 2102 may include silica gel, rubber, liquid damping material, etc. By means of the good viscoelastic performance of the rotating shaft 2102, a frictional force may be produced between it and its contacted components, to enable the lamp body 10 to remain suspended at a predetermined rotation angle after the external force is removed. In some embodiments, damping oil may also be added to a contact part between the lamp body 10 and the rotating shaft 2102 to improve the damping effect.

The rotational damping may exist between the rotating shaft 2102 and the fixing members 11342. Specifically, the rotating shaft 2102 may be in interference fit with the two fixing members 11342. When the rotating shaft 2102 is rotated relative to the first shaft holes 11352 under the action of an external force, the rotating shaft 2102 and the two fixing members 11342 contact each other and a frictional force is generated, and the frictional force generated between the two provides the rotational damping. The rotational damping enables the lamp body 10 to remain suspended when rotating to a specific position, without changing the position after the removal of the external force. The magnitude of interference fit between the rotating shaft 2102 and the two fixing members 11342 ranges from 0.1 mm to 1 mm. For example, the magnitude of interference fit between the rotating shaft 2102 and the two fixing members 11342 may be 0.1 mm, 0.2 mm, 0.5 mm, 1 mm, etc. The magnitude of interference fit between the rotating shaft 2102 and the two fixing members 11342 may also be other values to improve the rotational damping between them and thus the suspended effect.

Further, the rotational damping may also exist between the penetrating member 232 and the second shaft hole 2112 to ensure the reliability of suspending. Specifically, the penetrating member 232 is received in the second shaft hole 2112 and contacts the inner wall surface of the second shaft hole 2112. When the rotating shaft 2102 is rotated relative to the first shaft holes 11352 under the action of the external force, the penetrating member 232 is also rotated accordingly. The penetrating member 232 may be in interference fit with the inner wall of the second shaft hole 2112, so that a corresponding frictional force is generated between the penetrating member 232 and the second shaft hole 2112 to provide rotational damping. The rotating shaft 2102 and the lamp body 10 can remain suspended under the action of the rotational damping, that is, the lamp body 10 can stably suspend after being adjusted to the desired position relative to the base, and change of the position that would be caused due to the own weight or an external force does not occur.

By providing the above rotational connection mechanism 20, the lamp body 10 can be rotated relative to the base 30 around the preset axis O1, so that the lighting direction of the lighting device 100 can be adjusted as needed to improve the light output effect. The rotational damping between the rotational connection mechanism 20 and the lamp body 10 not only ensures the tight connection between the rotating shaft 2102 and the fixing members 11342, and improves the stability of the entire rotating system, but also enables the lamp body 10 to remain suspended at a predetermined rotation angle. The way to realize the suspending is simple, without providing an additional friction plate or fastening device.

In the embodiments, in order to facilitate the quick connection of the rotational connection mechanism 20 to the base 30, the rotational connection mechanism 20 further includes a positioning protrusion 252. The positioning protrusion 252 is connected to the rotating shaft 2102 and protrudes toward the base 30, and is configured to realize the quick positioning and installation of the rotating shaft 2102 to the base 30. Specifically, the base 30 is provided with a positioning groove 32, and the positioning protrusion 252 protrudes toward the positioning groove 32 and is detachably accommodated in the positioning groove 32.

In the lighting device 100 provided in the above embodiments of the present disclosure, there is rotational damping during the rotation of the lamp body 10. The lamp body 10 can remain suspended at a predetermined angle under the action of the rotational damping. The suspending operation is simple and fast without providing an additional locking mechanism, which can improve the operation efficiency and the user's use experience.

The present disclosure also provides a lamp, which includes a control box and the lighting device provided in any embodiment of the present disclosure. The lighting device is electrically connected to the control box. The lamp has the beneficial effects of the corresponding structure of the lighting device. The lamp may be a wall washer lamp, a fence lamp, an eave lamp, etc.

It is notable that the foregoing describes only the preferred embodiments of the present disclosure and the technical principles applied thereto. Those skilled in the art will understand that the present disclosure is not limited to the specific embodiments described herein. For those skilled in the art, various obvious changes, adjustments, and substitutions can be made without departing from the protection scope of the present disclosure. Therefore, although the present disclosure has been described in detail with reference to the above embodiments, the present disclosure is not limited to the above embodiments, and may also include more other equivalent embodiments made without departing from the concept of the present disclosure. The scope of the present disclosure is determined by the scope of the appended claims.

What is claimed is:

1. A lighting device, comprising at least two light sources and a plurality of lenses, the plurality of lenses being in one-to-one correspondence with the at least two light sources;
wherein each of the lenses is configured to receive and converge emitted light from a corresponding light source, at least a part of a periphery of each of the lenses is arc-shaped, the plurality of lenses are symmetrically arranged, and each of the lenses is configured to make outgoing light therefrom define a zoned light spot, in such a manner that an integral fan-shaped light spot is defined by all the zoned light spots.

2. The lighting device as claimed in claim 1, wherein the at least two light sources have a same emission angle.

3. The lighting device as claimed in claim 1, wherein the number of the plurality of lenses is odd, the plurality of lenses comprise a central lens whose optical axis coincides with an optical axis of the fan-shaped light spot, and other lenses except the central lens are symmetrically arranged on both sides of the central lens.

4. The lighting device as claimed in claim 3, wherein an angle between an optical axis of an i-th other lens on each side of the central lens and the optical axis of the fan-shaped light spot is i*N/M, where N represents a degree of a central angle of the fan-shaped light spot, M represents the number of the plurality of lenses, and i is a positive integer less than or equal to (M−1)/2.

5. The lighting device as claimed in claim 1, wherein the number of the plurality of lenses is even, and the plurality of lenses are symmetrically arranged on both sides of the optical axis of the fan-shaped light spot.

6. The lighting device as claimed in claim 5, wherein an angle between an optical axis of the fan-shaped light spot and an optical axis of an i-th lens on each side of the optical axis of the fan-shaped light spot is (2i−1)*N/(2M), where N represents a degree of a central angle of the fan-shaped light spot, M represents the number of the plurality of lenses, and i is a positive integer less than or equal to M/2.

7. The lighting device as claimed in claim 1, wherein the lighting device further comprises a light mixing cover provided in a light emission direction of each of the plurality of light sources.

8. The lighting device as claimed in claim 1, wherein the lighting device further comprises a light-blocking member; the light-blocking member is provided around each of the plurality of lenses and provided between every two adjacent lenses of the plurality of lenses.

9. The lighting device as claimed in claim 1, further comprising a lamp body, a rotational connection mechanism, and a base; the rotational connection mechanism is connected between the base and the lamp body, and the lamp body is rotatable relative to the base around a preset axis via the rotational connection mechanism;
the lamp body comprises:
a housing assembly, wherein the housing assembly is connected to the rotational connection mechanism, and the housing assembly is provided with a light outlet;
a light-emitting module, wherein the light-emitting module comprises the at least two light sources, and is provided in the housing assembly; and
a lampshade, wherein the lampshade comprises the plurality of lenses, and is provided at and covers the light outlet;
wherein a light-emitting side of the light-emitting module is configured to face the light outlet; a direction from the light-emitting side to the light outlet is defined as a light emission direction of the light-emitting module, and the preset axis intersects the light emission direction of the light-emitting module.

10. The lighting device as claimed in claim 9, wherein the rotational connection mechanism comprises a support member and a rotating shaft portion; the support member is connected to the base and configured to protrude toward the lamp body; the lighting device is further provided with a shaft hole; the rotating shaft portion is provided on one of the support member and the housing assembly, and the shaft hole is correspondingly provided on the other of the support member and the housing assembly; and the rotating shaft portion is rotatably received in the shaft hole.

11. The lighting device as claimed in claim 10, wherein the rotational connection mechanism further comprises: a positioning portion provided on the support member; an extension member connected between the housing assembly and the support member; and a matching portion provided on a side of the extension member away from the housing assembly; and
the positioning portion and the matching portion are configured to, when the rotating shaft portion is movably connected to the shaft hole, be cooperatively connected to limit a relative position between the housing assembly and the base.

12. The lighting device as claimed in claim 11, wherein the positioning portion comprises a protruding structure, and the matching portion comprises a plurality of grooves arranged side by side; the plurality of grooves are located on a rotation path on which the lamp body is rotated relative to the base, and the protruding structure is rotatably clamped in one of the plurality of grooves.

13. The lighting device as claimed in claim 10, wherein the number of the support members is two, and the two support members are opposite to and spaced apart from each other; the rotational connection mechanism further comprises two extension members connected to the housing assembly, and the two support members are located between the two extension members and arranged in one-to-one correspondence with the two extension members;
the number of the rotating shaft portions are two, and the two rotating shaft portions are provided on the two support members respectively; the number of the shaft holes is two, each of the two extension members is provided with one of the two shaft holes, and each of the two extension members is opposite to and stacked with a corresponding support member to make the two rotating shaft portions received in the two shaft holes respectively.

14. The lighting device as claimed in claim 9, wherein there is rotational damping when the lamp body is rotated relative to the base around the preset axis via the rotational connection mechanism, and the lamp body is capable of remaining suspended relative to the base under action of the rotational damping.

15. The lighting device as claimed in claim 14, wherein the rotational connection mechanism comprises a rotating shaft and a fixing portion connected to the rotating shaft; the fixing portion is fixed connected to the base, the rotating shaft is rotatably connected to the housing assembly, and the rotational damping is generated when the housing assembly is rotated relative to the base via the rotating shaft.

16. The lighting device as claimed in claim 15, wherein the housing assembly is provided with two fixing members on a side of the housing assembly facing the base, the two fixing members are spaced apart from each other, and the rotating shaft is located between the two fixing members;
the rotational connection mechanism further comprises a penetrating member configured to pass through the fixing members and the rotating shaft to make the housing assembly rotatably connected to the base.

17. The lighting device as claimed in claim 16, wherein the rotational connection mechanism further comprises fasteners; the fasteners are connected to the penetrating member, and the fasteners are configured to tightly abut against both sides of the two fixing members respectively, so that the two fixing members jointly clamp two ends of the rotating shaft, and the rotational damping is provided by a frictional force between the rotating shaft and the two fixing members.

18. The lighting device as claimed in claim 16, wherein each of the two fixing members is provided with a first shaft hole, the rotating shaft is provided with a second shaft hole, and the penetrating member is configured to pass through the second shaft hole and the first shaft holes; the penetrating member is in interference fit with the second shaft hole, and the rotational damping is provided by a frictional force between a hole wall of the second shaft hole and the penetrating member.

19. The lighting device as claimed in claim 9, wherein the housing assembly is provided with an accommodating space, and the light outlet is communicated with the accommodating space; the light-emitting module further comprises a substrate, the substrate is provided in the accommodating space and spaced apart from the light outlet, and the at least two light sources are provided on a side of the substrate facing the light outlet;
the lighting device further comprises a potting sealing element filled in a space between the substrate and the lampshade; and
the housing assembly comprises a housing and a bottom cover, and the bottom cover comprises a cover body and a plug connector connected to the cover body; the cover body is connected to the substrate and located on a side of the substrate away from the light outlet; the plug connector is configured to protrude toward a side away from the cover body, one end of the plug connector is connected to the cover body, and the other end of the plug connector is inserted into the potting sealing element after passing through a gap between the substrate and the housing.

20. A lamp, comprising a control box and a lighting device electrically connected with each other, wherein the lighting device comprises:
at least two light sources; and
at least two lenses, wherein the at least two lenses are in one-to-one correspondence with the at least two light sources, each of the at least two lenses is configured to receive and converge emitted light from a corresponding light source, the at least two lenses are symmetrically arranged, at least a part of a periphery of each of the at least two lenses is arc-shaped, and each of the lenses is configured to make outgoing light therefrom define a zoned light spot so that an integral fan-shaped light spot is defined by all the zoned light spots.
